(19) United States
(12) Patent Application Publication
(10) Pub. No.: US 2003/0194102 A1
(43) Pub. Date: Oct. 16, 2003

(54) Electroacoustic transducer

(76) Inventors: Takashi Yamasaki, Tokyo (JP); Kenichi Kidokoro, Tokyo (JP)

Correspondence Address: Carrier Blackman & Associates, Suite 100, 24101 Novi Road, Novi, MI, 48375, US

(21) Appl. No.: 10/297,141

(22) PCT Filed: Apr. 11, 2002
(86) PCT No.: PCT/JP02/03622

(51) Int. Cl. H04R 25/00

(52) U.S. Cl. 381/174; 381/150; 381/191

(57) ABSTRACT

The object of the present invention is to provide an electroacoustic transducer characterized in that the desirable tension of a diaphragm is not changed, the interval between the diaphragm and the electrode portion can accurately be kept, the amplitude of the diaphragm in response to sound waves can be increased, and the influence of an external force can be reduced. According to an aspect of the present invention, there is provided an electroacoustic transducer comprising a carrier portion, a diaphragm supported by the carrier portion, an electrode portion opposed to the diaphragm at a predetermined interval, and a housing for accommodating the diaphragm and the electrode portion, wherein the carrier portion has a saucer-like shape, at the bottom surface of which a plurality of posts are provided, and wherein the surface of the periphery of the carrier portion and the end surfaces of the posts are allowed to be in the same plane, the diaphragm is bonded to the surface of the periphery of the carrier portion and the end surfaces of the posts, and the electrode portion is fixed to the end surfaces of the posts which are covered by the diaphragm with spacers interposed therebetween.

### TECHNICAL FIELD

The present invention relates to an electroacoustic transducer in which a diaphragm supported by a carrier portion and an electrode portion opposed to the diaphragm at a predetermined interval are accommodated in a housing, such as a microphone for use in a hearing aid or the like.

### BACKGROUND ART

As a conventional microphone for use in a hearing aid, as disclosed in U.S. Pat. No. 6,169,810 B1, there has been known an electroacoustic transducer in which a diaphragm having a conductive layer and an electrode portion having an electret layer are accommodated in a housing in a state where the electrode portion is opposed to the diaphragm at a predetermined interval by clamping the diaphragm on a frame-shaped carrier having inwardly-extending supporting portions and placing the electrode portion on the supporting portions with spacers interposed therebetween.

However, as for such a diaphragm clamped on a frame-shaped carrier having inwardly-extending supporting portions, the amplitude in response to sound waves is greatly limited compared to a case of no supporting portions because the supporting portions are a point where the vibration of the diaphragm is initiated.

In addition, since the carrier is a rectangular shaped frame body, there is a problem that the carrier cannot keep its flatness due to a strain or twist which is applied thereto along the diagonal. Such a problem has an undesirable influence on the tension of the diaphragm or the interval between the diaphragm and the electrode portion. Therefore, since it is necessary to prevent the carrier from being subject to a strain or twist at the time of assembling an electroacoustic transducer, the stable manufacture of an electroacoustic transducer is difficult.

In order to solve the above-mentioned problems, the object of the present invention is to provide an electroacoustic transducer, characterized in that the desirable tension of a diaphragm is not changed, the interval between the diaphragm and the electrode portion can accurately be kept, the amplitude of the diaphragm in response to sound waves can be increased, and the influence of an external force can be reduced.

### DISCLOSURE OF THE INVENTION

According to an aspect of the present invention, there is provided an electroacoustic transducer comprising a carrier portion, a diaphragm supported by the carrier portion, an electrode portion opposed to the diaphragm at a predetermined interval, and a housing for accommodating the diaphragm and the electrode portion, wherein the carrier portion has a saucer-like shape, at the bottom surface of which a plurality of posts are provided, and wherein the surface of the periphery of the carrier portion and the end surfaces of the posts are allowed to be in the same plane, the diaphragm is bonded to the surface of the periphery of the carrier portion and the end surfaces of the posts, and the electrode portion is fixed to the end surfaces of the posts which are covered by the diaphragm with spacers interposed therebetween.

According to another aspect of the present invention, in the above-mentioned electroacoustic transducer, the diaphragm is formed in a film shape having a conductive layer provided on the surface of the diaphragm which faces the electrode portion or the other surface of the diaphragm, and the electrode portion has an electret layer and also has protruding portions provided on the surface of the electrode portion which faces the diaphragm, the protruding portions functioning as the above-mentioned spacers.

According to another aspect of the present invention, in the above-mentioned electroacoustic transducer, a sound guide port is provided at the bottom of the carrier portion, and the inside of the housing is divided into a first acoustic chamber and a second acoustic chamber by bonding the bottom of the carrier to the bottom surface of the housing and bonding the periphery of the sound guide port to the inside wall of the housing.

According to another aspect of the present invention, in the above-mentioned electroacoustic transducer, the carrier portion is formed by an etching process.

### BRIEF DESCRIPTION OF THE DRAWINGS

FIG. 1 shows a cross-sectional view of an electroacoustic transducer according to the present invention;

FIG. 2 shows an enlarged cross-sectional view of the electroacoustic transducer according to the present invention;

FIG. 3 shows a plane view of a carrier portion of the electroacoustic transducer according to the present invention;

FIG. 4 shows a perspective view of the carrier portion of the electroacoustic transducer according to the present invention; and

FIG. 5 explains the etching process steps of the carrier portion.

### BEST MODE FOR CARRYING OUT THE INVENTION

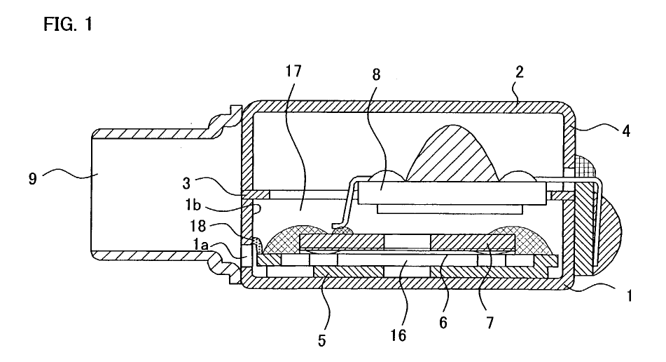

As shown in FIG. 1, in an electroacoustic transducer according to the present invention, a housing 4 is formed by interposing a frame member 3 between a case member 1 and a cover member 2. The housing 4 accommodates a diaphragm 6 and an electrode portion 7 fixed to a carrier portion 5. Reference numeral 8 refers to an amplifier and reference numeral 9 refers to a sound inlet opening.

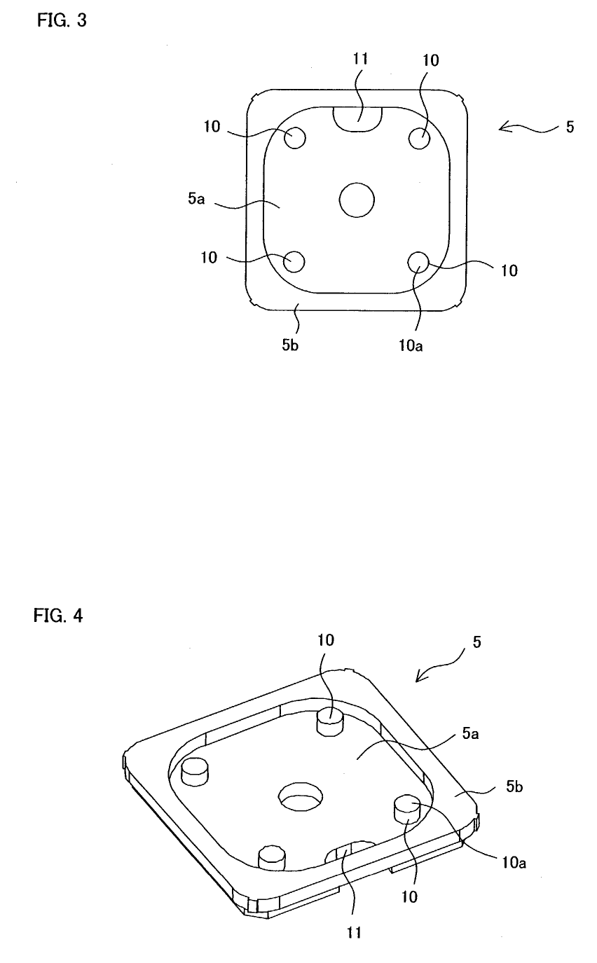

As shown in FIGS. 3 and 4, the carrier portion 5 is formed in a rectangular saucer-like shape which is accommodated in the case member 1. In the four corners of the bottom surface 5a of the carrier portion 5, there is provided posts 10 in an island-like pattern, and the surface 5b of the periphery of the carrier portion 5 and the end surfaces 10a of the posts 10 are allowed to be in the same plane. Reference numeral 11 refers to a sound guide port 11 for guiding sound waves. Since the carrier portion 5 is formed by an etching process as mentioned below, it is possible to prevent a strain or stress from being left in the carrier portion 5 which may occur in a case of press processing. Also, since the carrier portion 5 is formed in a saucer-like shape having a bottom portion rather than a frame shape, the carrier portion 5 has a strong structure with respect to the external force compared to a frame-shaped carrier.

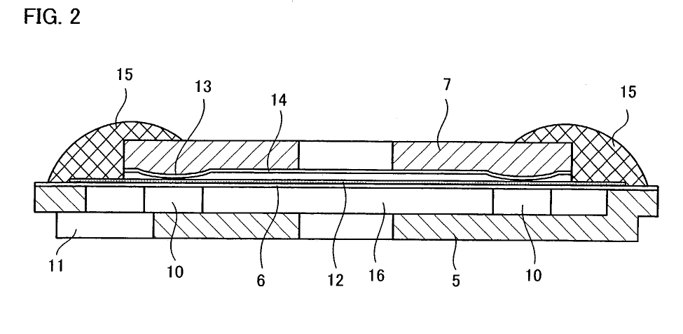

As shown in FIG. 2, the diaphragm 6 is formed in a film shape having a conductive layer 12 provided on the surface of the diaphragm 6 which faces the electrode portion 7. The diaphragm 6 is bonded in a state of desired tension to the surface 5b of the periphery of the carrier portion 5 and the end surfaces 10a of the posts 10 to which an adhesive has been applied. Since the carrier portion 5 is formed by an etching process so as to have no influence of a strain nor stress, the variation in the tension of the diaphragm 6 is kept to be uniform even when the ambient temperature varies. Also, since the surface 5b of the periphery of the carrier portion 5 and the end surfaces 10a of the posts 10 are in the same plane, uniform and desired tension of the diaphragm 5 can be achieved. It should be noted that the diaphragm 6 may be formed in a film shape having a conductive layer 12 provided on the surface of the diaphragm 6 which is opposite to the surface of the diaphragm 6 which faces the electrode portion 7.

The electrode portion 7 has an electret layer 14 and also has protruding portions 13 provided on the surface of the electrode portion 7 which faces the diaphragm 6. The electrode portion 7 is fixed to the carrier portion 5 by an adhesive 15 in a state where the protruding portions 13 abut on the end surfaces 10a of the posts 10 which are covered by the diaphragm 6. Since the end surfaces 10a of the posts 10 in the four corners of the carrier portion 5 are formed so as to be in the same plane by an etching process, it is easy to keep the diaphragm 6 and the electret layer 14 of the electrode portion 7 parallel at a certain interval.

The bottom of the carrier portion 5 having the diaphragm 6 and the electrode portion 7 fixed thereto is bonded to the bottom surface of the case member 1 by an adhesive. In addition, the periphery of the sound guide port 11 is bonded to the inside wall 1b of the case member 1 by an adhesive 18.

Moreover, the cover member 2 is bonded to the case member 1 accommodating the carrier portion 5 having the diaphragm 6 and the electrode portion 7 fixed thereto with the frame member 3 interposed between the cover member 2 and the case member 1, and thereby the housing 4 is formed and the electroacoustic transducer according to the present invention is completed.

The inside space of the housing 4 is divided into a first acoustic chamber 16 and a second acoustic chamber 17. The first acoustic chamber 16 is defined by the carrier portion 5 and the diaphragm 6, and the second acoustic chamber 17 is the other portion of the inside space of the housing 4. Since the carrier portion 5 is formed in a saucer-like shape, it is possible to define the first acoustic chamber 16 only by bonding the diaphragm 6 to the surface 5b of the periphery of the carrier portion 5 and the end surfaces 10a of the posts 10 without taking sealing into consideration. Accordingly, it is easy to divide the inside space of the housing 4 into the first acoustic chamber 16 and the second acoustic chamber 17.

Sound waves enter from the sound inlet opening 9, pass a sound passage 1a provided in the side surface of the case member 1 and the sound guide port 11 formed in the carrier portion 5 to the first acoustic chamber 16, and reach the diaphragm 6. The sound pressure of the sound waves vibrates the diaphragm 6, which causes the variation in the capacitance between the diaphragm 6 and the electrode portion 7. As a result of this, the amplifier 8 outputs electrical signals depending on the sound waves.

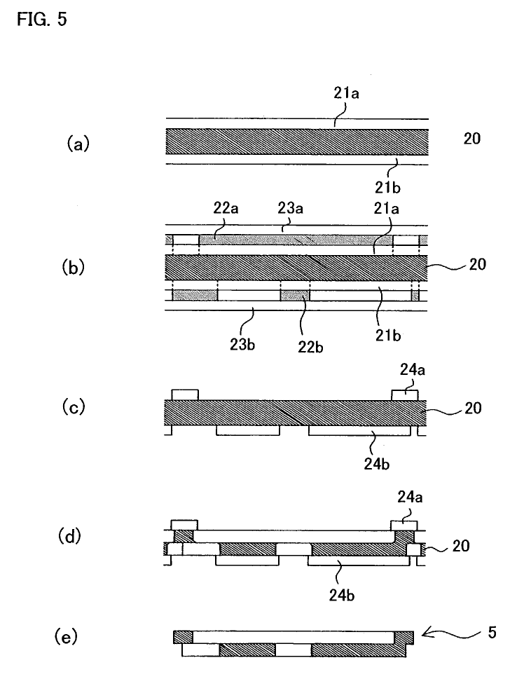

Next, explanations will be made on the processes of producing the carrier portion 5 by an etching process with reference to FIG. 5. The shape of the carrier portion 5 can be formed by conducting an etching process to a metal plate with two photomasks having a different shape applied to each surface of the metal plate.

As shown in FIG. 5(a), resist layers 21a, 21b are respectively attached to both surfaces of a metal plate 20 which will form the carrier portion 5.

As shown in FIG. 5(b), photomasks 22a, 22b having a desired pattern are respectively attached to the resist layers 21a, 21b, and bases 23a, 23b for a photomask are respectively attached to the photomasks 22a, 22b. Ultraviolet rays are radiated to both surfaces, and thereby mask patterns of the photomasks 22a, 22b are exposed to the resist layers 21a, 21b.

As shown in FIG. 5(c), the photomasks 22a, 22b and the bases 23a, 23b for a photomask are removed, and thereafter the portion of the resist layers 21a, 21b which has been covered by the photomasks 22a, 22b is dissolved with a parting agent. The portion of the resist layers 21a, 21b which has not been covered by the photomasks 22a, 22b (hereinafter, referred to as resist layers 24a, 24b) is left on the metal plate 20.

Next, as shown in FIG. 5(d), both surfaces of the metal plate 20, which are exposed without being covered by the resist layers 24a, 24b, are dissolved with a strong acid so as to obtain a desired shape for the carrier portion 5.

Finally, as shown in FIG. 5(e), the resist layers 24a, 24b are dissolved with a different parting agent from the parting agent used in the above-mentioned process of FIG. 5(c) so as to obtain a desired shape for the carrier portion 5. The shape of the carrier portion 5 which is formed from the metal plate 20 can be determined depending on patterns of the photomasks 22a, 22b.

In addition, when a metal plate 20 which enables to make a plurality of carrier portions 5 is prepared, and resist layers 21a, 21b, photomasks 22a, 22b, and bases 23a, 23b for a photomask which conform to such a metal plate are used, a plurality of carrier portions 5 can be formed at the same time, and thereby high productivity and low costs can be achieved.

### INDUSTRIAL APPLICABILITY

According to an aspect of the present invention, since the carrier portion is formed in a saucer-like shape having a bottom portion rather than a frame shape, the carrier portion has a strong structure with respect to an external force and it is possible to prevent the tension of the diaphragm from being influenced by an external force. Since the surface of the periphery of the carrier portion and the end surfaces of the posts are in the same plane, uniform and desired tension of the diaphragm can be achieved. In addition, since the end surfaces of the posts are formed so as to be in the same plane by an etching process, it is easy to keep the diaphragm and the electrode portion parallel at a certain interval.

According to another aspect of the present invention, it is easy to keep the diaphragm and the electret layer of the electrode portion parallel at a certain interval.

According to another aspect of the present invention, since the carrier portion is formed in a saucer-like shape, it is possible to define the first acoustic chamber only by bonding the diaphragm to the surface of the periphery of the carrier portion and the end surfaces of the posts. Accordingly, it is easy to divide the inside space of the housing into the first acoustic chamber and the second acoustic chamber.

According to another aspect of the present invention, since the carrier portion is formed by etching processing, it is possible to prevent a strain or stress from being left in the carrier portion which may occur in a case of press processing. Since the carrier portion is formed by an etching process so as to have no influence of a strain nor stress, the variation in the tension of the diaphragm is kept to be uniform even when the ambient temperature varies. In addition, since the end surfaces of the posts are formed so as to be in the same plane by an etching process, it is easy to keep the diaphragm and the electrode portion parallel at a certain interval.

1. An electroacoustic transducer comprising:
a carrier portion;
a diaphragm supported by said carrier portion;
an electrode portion opposed to said diaphragm at a predetermined interval; and
a housing for accommodating said diaphragm and said electrode portion;
wherein said carrier portion has a saucer-like shape, at the bottom surface of which a plurality of posts are provided, and wherein the surface of the periphery of said carrier portion and the end surfaces of said posts are allowed to be in the same plane, said diaphragm is bonded to said surface of the periphery of the carrier portion and said end surfaces of the posts, and said electrode portion is fixed to said end surfaces of the posts which are covered by said diaphragm with spacers interposed therebetween.

2. The electroacoustic transducer according to claim 1, wherein said diaphragm is formed in a film shape having a conductive layer provided on the surface of said diaphragm which faces said electrode portion or the other surface of said diaphragm, and said electrode portion has an electret layer and also has protruding portions provided on the surface of said electrode portion which faces said diaphragm, said protruding portions functioning as said spacers.

3. The electroacoustic transducer according to claim 1 or 2, wherein a sound guide port is provided at the bottom of said carrier portion, and the inside of said housing is divided into a first acoustic chamber and a second acoustic chamber by bonding the bottom of said carrier to the bottom surface of said housing and bonding the periphery of said sound guide port to the inside wall of said housing.

4. The electroacoustic transducer according to any one of claims 1 to 3, wherein said carrier portion is formed by an etching process.
